(19) United States
(12) Patent Application Publication
(10) Pub. No.: US 2025/0361371 A1
(43) Pub. Date: Nov. 27, 2025

(54) COMPOSITE ARTICLE AND METHOD OF FORMING A COMPOSITE ARTICLE

(71) Applicant: SAINT-GOBAIN PERFORMANCE PLASTICS CORPORATION, Solon, OH (US)

(72) Inventors: Nicholas WATKINS, Natick, MA (US); Hua WANG, Northbridge, MA (US); Jianfeng ZHANG, Shrewsbury, MA (US)

(21) Appl. No.: 19/216,057

(22) Filed: May 22, 2025

Related U.S. Application Data
(60) Provisional application No. 63/650,508, filed on May 22, 2024.

(51) Int. Cl. C08J 7/056; B05D 1/18; B05D 5/08; B05D 7/02; C08J 3/24; C08J 7/04

(52) U.S. Cl. CPC C08J 7/056; B05D 1/18; B05D 5/08; B05D 7/02; C08J 3/24; C08J 7/0427; B05D 2201/02; B05D 2252/10; B05D 2254/06; B05D 2400/00; B05D 2401/20; B05D 2518/00; C08J 2329/04; C08J 2371/00; C08J 2377/00; C08J 2383/04

(57) ABSTRACT

The present disclosure relates to a method of forming a composite article. The method includes: providing a structural component with a surface, wherein the surface includes a silicone elastomer, a fluoropolymer, or a copolymer or a block copolymer; optionally pre-treating the surface with a plasma treatment; coating the surface of the structural component with a precursor coating component, wherein the precursor coating component including a polyvinyl alcohol based component, and treating the precursor coating component to form a crosslinked coating layer overlying the surface of the structural component.

### CROSS-REFERENCE TO RELATED APPLICATION(S)

This application claims priority under 35 U.S.C. § 119 (e) to U.S. Provisional Patent Application No. 63/650,508 entitled “COMPOSITE ARTICLE AND METHOD OF FORMING A COMPOSITE ARTICLE,” filed May 22, 2024, by Nicholas WATKINS et al., which is assigned to the current assignee hereof and is incorporated herein by reference in its entirety.

### FIELD OF THE DISCLOSURE

The present disclosure is related to a composite article and, more particularly, a composite article formed with a crosslinked coating component.

### BACKGROUND

Surface modification may be desirable in order to impart properties to a surface of an article. For instance, a material may have desirable bulk properties but surface properties that are undesirable for certain applications. Unfortunately, modification of certain inert materials may be difficult.

Accordingly, a modified surface and method of modifying an inert surface is desired.

### SUMMARY

According to a first aspect, a method of forming a composite article is provided. The method includes: providing a structural component with a surface, wherein the surface includes a silicone elastomer, a fluoropolymer, a copolymer or a block polymer including a polyolefin block, a polyether block, a polyurethane block, a polyamide block, a polyester block, a styrene block copolymer, a polyvinyl chloride (PVC), or any combination thereof; optionally pre-treating the surface with an ionized gas treatment; coating the surface of the structural component with a precursor coating component, wherein the precursor coating component includes a polyvinyl alcohol based component, and treating the precursor coating component to form a crosslinked coating layer overlying the surface of the structural component.

According to yet another aspect, a composite article includes a structural component including a surface including a silicone elastomer, a fluoropolymer, a copolymer or a block polymer including a polyolefin block, a polyether block, a polyurethane block, a polyamide block, a polyester block, a styrene block copolymer, a polyvinyl chloride (PVC), or any combination thereof, and a crosslinked coating layer overlying the surface of the structural component, wherein the crosslinked coating layer includes a polyvinyl alcohol based component.

According to still another aspect, a tubular article includes an inner surface including a silicone elastomer, and a crosslinked coating layer overlying the inner surface of the tubing component, wherein the crosslinked coating layer includes a polyvinyl alcohol based component.

In another aspect, a container article includes an inner surface including a silicone elastomer, and a crosslinked coating layer overlying the inner surface of the tubing component, wherein the crosslinked coating layer includes a polyvinyl alcohol based component.

### BRIEF DESCRIPTION OF THE DRAWINGS

Embodiments are illustrated by way of example and are not limited to the accompanying figures.

FIG. 1 includes a diagram showing a composite article forming method according to embodiments described herein;

FIG. 2 includes an illustration showing the configuration of a composite article formed according to embodiments described herein;

FIG. 3 includes an illustration showing the configuration of a tubular article formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a composite article having a structural component with a surface, and a coating component overlying the surface of the structural component. The coating component may include a crosslinked coating layer. The crosslinked coating layer may include a polyvinyl alcohol based component.

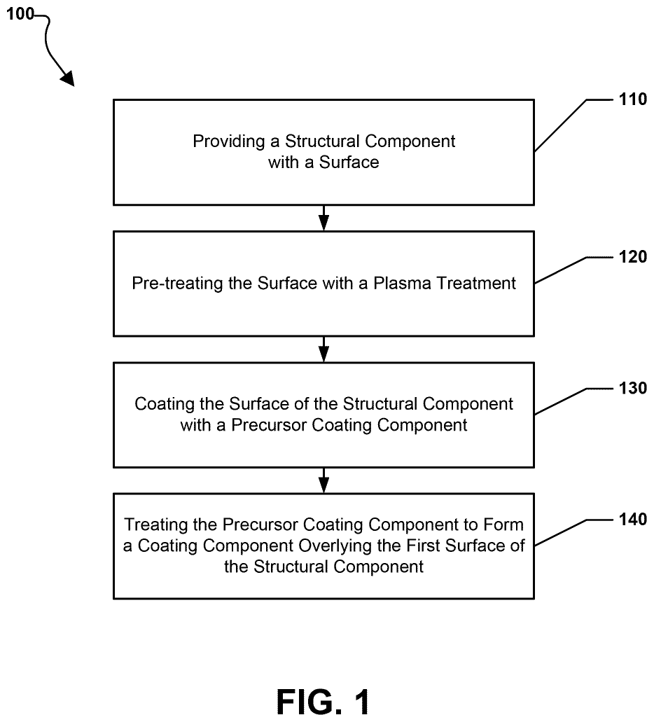

Referring first to a method of forming a composite article described herein, FIG. 1 includes a diagram showing a forming method 100 according to embodiments described herein for forming a composite article. According to particular embodiments, the forming method 100 may include a first step 110 of providing a structural component with a surface, an optional second step 120 of pre-treating the surface with a plasma treatment, a third step 130 of coating the surface of the structural component with a precursor coating component, and a fourth step 140 of treating the precursor coating component to form a coating component overlying the surface of the structural component.

Referring specifically to the first step 110 of providing the structural component with a surface, according to particular embodiments, the surface of the structural component may include a particular material. In an exemplary embodiment, the surface of the structural component includes a silicone elastomer. A typical silicone elastomer includes a silicone matrix component. An exemplary silicone matrix component includes a polyorganosiloxane. Polyorganosiloxanes include a polyalkylsiloxane, a polyarylsiloxane, or combination thereof. Any reasonable polyalkylsiloxane is envisioned. Polyalkylsiloxanes include, for example, silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. The vinyl group may be an endblock of the polyalkylsiloxane, on chain of the polyalkylsiloxane, or any combination thereof. In yet another embodiment, the silicone matrix component is a combination of a hydride-containing polyalkylsiloxane and a vinyl-containing polyalkylsiloxane. According to a particular embodiment, the structural component may consist of a silicone elastomer.

According to another embodiment, the surface of the structural component may include a fluoropolymer. According to still other embodiments, the fluoropolymer included in the surface of the structural component may include polytetrafluoroethylene (PTFE), fluorinated ethylene propylene (FEP), perfluoroalkoxy alkane (PFA), polyvinylidene fluoride (PVDF), ethylene tetrafluoroethylene (ETFE), or any combination thereof. According to still other embodiments, the surface of the structural component may consist of a fluoropolymer. According to still other embodiments, the fluoropolymer included in the structural component may consist of polytetrafluoroethylene (PTFE), fluorinated ethylene propylene (FEP), perfluoroalkoxy alkane (PFA), polyvinylidene fluoride (PVDF), ethylene tetrafluoroethylene (ETFE), or any combination thereof.

In another embodiment, the surface of the structural component may include a copolymer or block polymer. According to certain embodiments, the copolymer or block polymer included in the surface of the structural component may include a polyolefin block, a polyether block, a polyurethane block, a polyamide block, a polyester block, a styrene block copolymer, a polyvinyl chloride (PVC), or any combination thereof. According to particular embodiments, the surface of the structural component may consist of a particular material. For example, the surface of the structural component may consist of a copolymer or block polymer. According to certain embodiments, the copolymer or block polymer included in the surface of the structural component may consist of a polyolefin block, a polyether block, a polyurethane block, a polyamide block, a polyester block, a styrene block copolymer, a polyvinyl chloride (PVC), or any combination thereof.

According to particular embodiments, the surface of the structural component may include a polyether block amide. According to yet other embodiments, the surface of the structural component may consist of a polyether block amide.

According to still other embodiments, the structural component may have a particular thickness. For example, the structural component may have a thickness of at least about 0.025 mm, such as, at least about 0.05 mm or at least about 0.075 mm or at least about 0.1 mm or at least about 5 mm or at least about 10 mm or at least about 15 mm or at least about 20 mm or at least about 25 mm or at least about 50 mm or at least about 75 mm or at least about 100 mm or even at least about 125 mm. According to yet other embodiments, the structural component may have a thickness of not greater than about 250 mm, such as, not greater than about 225 mm or not greater than about 200 mm or not greater than about 175 mm or even not greater than about 150 mm. It will be appreciated that the thickness of the structural component may be within a range between and including any of the minimum and maximum values noted above. It will be further appreciated that the thickness of the structural component may be any value between and including any of the minimum and maximum values noted above.

Referring next to the second step 120 of optionally pre-treating the surface with an ionized gas treatment, any ionized gas treatment is envisioned. An ionized gas treatment includes, for example, corona treatment, plasma treatment, ion treatment, or combination thereof. For instance, the corona treatment ionizes the atmosphere to activate the surface of the structural component. In an embodiment, the ionized gas treatment includes plasma treatment, which ionizes a gas such as oxygen, helium, argon, nitrogen, compressed air, water vapor, or combination thereof. Any conditions of the ionized gas treatment are envisioned that activate the surface. For instance, the plasma treatment is provided for less than 5 minutes, such as less than 2 minutes, such as less than 1 minute, such as less than 45 seconds, such as less than 30 seconds, or even less than 10 seconds. In an embodiment, the step of pre-treating with an ionized gas treatment provides a surface that has increased surface hydrophilicity compared to a surface that is not pre-treated. Although not being bound by theory, it is surmised that the pre-treatment process for the surface cleaning and adding hydrophilic moieties to the surface, increasing the affinity of the surface to the precursor coating component. In an embodiment, the pre-treatment is desirable when the surface includes a silicone elastomer. In another embodiment, the pre-treatment is desirable when the surface includes a copolymer or block polymer such as a polyolefin block, a polyurethane block, a polyester block, a styrene block copolymer, a polyvinyl chloride (PVC), or any combination thereof.

Referring next to the third step 130 of coating the surface of the structural component with a precursor coating component, coating the surface of the structural component may include a wet-coating process.

According to particular embodiments, the wet-coating process may be dip coating process. According to particular embodiments, the dip-coating process may include passing the structural component through a coating solution, such as dipping the structural component in the coating solution. According to still other embodiments, the coating solution may include a polyvinyl alcohol based component and water. In an embodiment, the total weight percent of the polyvinyl alcohol based component in the coating solution is less than 20 percent, such as less than 10 percent, such as less than 5 percent, such as less than 2 percent, such as less than 1 percent, based on the total weight percent of the coating solution.

According to other embodiments, the wet-coating process may be a spray coating process. According to particular embodiments, the spray-coating process may include spraying the structural component with a coating solution. According to still other embodiments, the coating solution may include a polyvinyl alcohol based component and water. In an embodiment, the total weight percent of the polyvinyl alcohol based component in the coating solution is less than 20 percent, such as less than 10 percent, such as less than 5 percent, such as less than 2 percent, such as less than 1 percent, based on the total weight percent of the coating solution.

According to still other particular embodiments, the wet-coating process may be a batch coating process. According to yet other embodiments, the wet-coating process may be a continuous coating process. In an embodiment, the wet-coating process includes more than one pass through the precursor coating component, such as multiple passes through the wet-coating process. Any number of passes is envisioned depending on the final properties desired for the composite article.

According to other embodiments, the precursor coating component may include a polyvinyl alcohol based component. According to particular embodiments, the polyvinyl alcohol based component of the precursor coating component may include a polyvinyl alcohol, a polyvinyl alcohol copolymer, a polyvinyl alcohol oligomer, or any combination thereof. According to other embodiments, the polyvinyl alcohol based component of the precursor coating component may consist of a polyvinyl alcohol, a polyvinyl alcohol copolymer, a polyvinyl alcohol oligomer, or any combination thereof.

According to specific embodiments, the precursor coating component may include a particular content of the polyvinyl alcohol based component. For example, the content of the polyvinyl alcohol based component in the precursor coating component may be at least about 75 wt. % for a total weight of the precursor coating component, such as, at least about 77 wt. % or at least about 80 wt. % or at least about 83 wt. % or at least about 85 wt. % or at least about 87 wt. % or at least about 90 wt. % or at least about 93 wt. % or at least about 95 wt. % or at least about 97 wt. % or even at least about 99 wt. %. According to still other embodiments, the content of the polyvinyl alcohol based component in the precursor coating component may be not greater than about 100 wt. % of the total weight of the precursor coating component. It will be appreciated that the polyvinyl alcohol based component content in the precursor coating component may be within a range between and including any of the minimum and maximum values noted above. It will be further appreciated that the polyvinyl alcohol based component content in the precursor coating component may be any value between and including any of the minimum and maximum values noted above.

According to still other embodiments, the precursor coating component may further include a secondary material. For example, the precursor coating component may further include poly(ethylene glycol) (PEG). According to still other embodiments, the precursor coating component may include chitosan. According to yet other embodiments, the precursor coating component may include poly(acrylic acid).

Referring next to the fourth step 140 of treating the precursor coating component to form a coating component overlying the surface of the structural component, treating the precursor coating component may include any process that causes the poly vinyl alcohol component within the precursor coating component to become cross-linked. According to certain embodiments, treating the precursor coating component may include any process that creates cross-links between a material within the precursor component and the surface of the structural component.

According to certain embodiments, treating the precursor coating component may include plasma treating the precursor coating component, ion beam treating the precursor coating component, e-beam radiation treating the precursor coating component, gamma radiation treating the precursor coating component, and the like. According to still other embodiments, treating the precursor coating component may include UV radiation cross-linking the precursor coating component.

Referring now to the composite article formed according to the forming method 100, the composite article may include a structural component having a surface, and a coating component overlying the surface of the structural component. The coating component may include a polyvinyl alcohol based component.

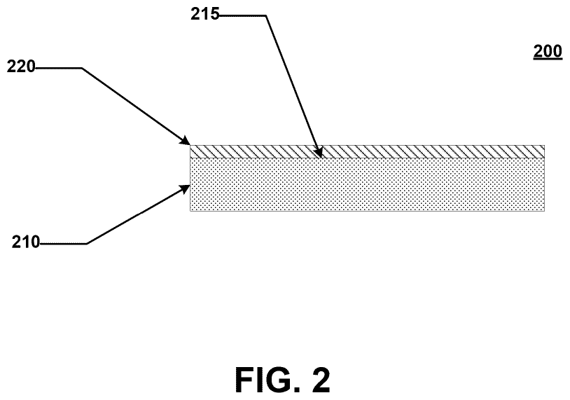

For purposes of illustration, FIG. 2 shows a composite article 200 formed according to embodiments described herein. As shown in FIG. 2, composite article 200 may include a structural component 210 having a surface 215 and a coating component 220 overlying the surface 215 of the structural component 210.

According to particular embodiments, the surface 215 of the structural component 210 may include a particular material. In an embodiment, the surface 215 of the structural component 210 may include a silicone elastomer. A typical silicone elastomer includes a silicone matrix component. An exemplary silicone matrix component includes a polyorganosiloxane. The polyorganosiloxane includes a polyalkylsiloxane, a polyarylsiloxane, or combination thereof. Any reasonable polyalkylsiloxane is envisioned. The polyalkylsiloxane includes, for example, a silicone polymer formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. The vinyl group may be an endblock of the polyalkylsiloxane, on chain of the polyalkylsiloxane, or any combination thereof. In yet another embodiment, the silicone matrix component is a combination of a hydride-containing polyalkylsiloxane and a vinyl-containing polyalkylsiloxane. According to a particular embodiment, the surface 215 of the structural component 210 may consist of a silicone elastomer.

According to another embodiment, the surface 215 of the structural component 210 may include a fluoropolymer. According to still other embodiments, the fluoropolymer included in the structural component may include polytetrafluoroethylene (PTFE), fluorinated ethylene propylene (FEP), perfluoroalkoxy alkane (PFA), polyvinylidene fluoride (PVDF), ethylene tetrafluoroethylene (ETFE), or any combination thereof. According to still other embodiments, the structural component may consist of a fluoropolymer. According to still other embodiments, the fluoropolymer included in the structural component may consist of polytetrafluoroethylene (PTFE), fluorinated ethylene propylene (FEP), perfluoroalkoxy alkane (PFA), polyvinylidene fluoride (PVDF), ethylene tetrafluoroethylene (ETFE), or any combination thereof.

For example, the surface 215 of the structural component 210 may include a copolymer or block polymer. According to certain embodiments, the copolymer or block polymer included in the structural component may include a polyolefin block, a polyether block, a polyurethane block, a polyamide block, a polyester block, a styrene block copolymer, a polyvinyl chloride (PVC), or any combination thereof. According to particular embodiments, the surface 215 of the structural component 210 may consist of a particular material. For example, the surface 215 of the structural component 210 may consist of a copolymer or block polymer. According to certain embodiments, the copolymer or block polymer included in the structural component may consist of a polyolefin block, a polyether block, a polyurethane block, a polyamide block, a polyester block, a styrene block copolymer, a polyvinyl chloride (PVC), or any combination thereof. According to particular embodiments, the surface 215 of the structural component 210 may include a polyether block amide.

According to still other embodiments, the structural component 210 may have a particular thickness. Any thickness is envisioned. For example, the structural component may have a thickness of at least about 0.025 mm, such as, at least about 0.05 mm or at least about 0.075 mm or at least about 0.1 mm or at least about 5 mm or at least about 10 mm or at least about 15 mm or at least about 20 mm or at least about 25 mm or at least about 50 mm or at least about 75 mm or at least about 100 mm or even at least about 125 mm. According to yet other embodiments, the structural component 210 may have a thickness of not greater than about 250 mm, such as, not greater than about 225 mm or not greater than about 200 mm or not greater than about 175 mm or even not greater than about 150 mm. It will be appreciated that the thickness of the structural component 210 may be within a range between and including any of the minimum and maximum values noted above. It will be further appreciated that the thickness of the structural component 210 may be any value between and including any of the minimum and maximum values noted above.

According to other embodiments, the coating component 220 may include a polyvinyl alcohol based component. According to particular embodiments, the polyvinyl alcohol based component of the coating component 220 may include a polyvinyl alcohol, a polyvinyl alcohol copolymer, a polyvinyl alcohol oligomer, or any combination thereof. According to other embodiments, the polyvinyl alcohol based component of the coating component 220 may consist of a polyvinyl alcohol, a polyvinyl alcohol copolymer, a polyvinyl alcohol oligomer, or any combination thereof.

According to specific embodiments, the coating component 220 may include a particular content of the polyvinyl alcohol based component. For example, the content of the polyvinyl alcohol based component in the coating component 220 may be at least about 75 wt. % for a total weight of the coating component 220, such as, at least about 77 wt. % or at least about 80 wt. % or at least about 83 wt. % or at least about 85 wt. % or at least about 87 wt. % or at least about 90 wt. % or at least about 93 wt. % or at least about 95 wt. % or at least about 97 wt. % or even at least about 99 wt. %. According to still other embodiments, the content of the polyvinyl alcohol based component in the coating component 220 may be not greater than about 100 wt. % of the total weight of the coating component 220. It will be appreciated that the polyvinyl alcohol based component content in the coating component 220 may be within a range between and including any of the minimum and maximum values noted above. It will be further appreciated that the polyvinyl alcohol based component content in the coating component 220 may be any value between and including any of the minimum and maximum values noted above.

According to still other embodiments, the coating component 220 may further include a secondary material. For example, the coating component 220 may further include poly(ethylene glycol) (PEG). According to still other embodiments, the coating component 220 may include chitosan. According to yet other embodiments, the coating component 220 may include poly(acrylic acid).

According to still other embodiments, the coating component 220 may have a particular thickness. For example, the coating component 220 may have a thickness of at least about 1 nm, such as, at least about 5 nm or at least about 10 nm or at least about 15 nm or at least about 20 nm or at least about 25 nm or at least about 30 nm or at least about 35 nm or at least about 40 nm or at least about 45 nm or even at least about 50. According to still other embodiments, the coating component 220 may have a thickness of not greater than about 2 μm, such as not greater than 1 μm, such as no greater than 500 nm, such as no great than 200 nm, such as not greater than about 150 nm, such as not greater than about 100 nm, such as not greater than about 95 nm or not greater than about 90 nm or not greater than about 85 nm or even not greater than about 80 nm. It will be appreciated that the thickness of the coating component 220 may be within a range between and including any of the minimum and maximum values noted above. It will be further appreciated that the thickness of the coating component 220 may be any value between and including any of the minimum and maximum values noted above.

According to certain embodiments, the polyvinyl alcohol based component is cross-linked. A component is considered cross-linked if at least one polymeric chain within the component is chemically bonded to another polymeric chain within the component. According to certain embodiments, the coating component 220 is cross-linked to the surface 215 of the structural component 210. A component is considered cross-linked to another component if at least one polymeric chain within a component is chemically bonded to another polymeric chain within the other component.

Any composite article is envisioned where properties such as low friction, low tack, high impermeability, low protein absorption, low fouling, low dust pick-up, chemical resistance, ability to incorporate additional functionalities, or combination thereof is desired. In an embodiment, the composite article includes a tube. In an embodiment, the composite article includes a container. Any container is envisioned. For instance, the container may be a bag or a cartridge used for cell culture. According to certain embodiments, the composite article as otherwise described herein (e.g., prepared according to a method as described herein) may be in the form of a catheter.

Embodiments described herein are further directed to a tubular article having a tubing component with a surface, and a coating component overlying the surface of the tubing component. In an embodiment, the surface is an inner surface of the tube. In another embodiment, the surface is the outer surface of the tube.

According to particular embodiments, the tubing component may include a particular material. For example, the tubing component may include a silicone elastomer or a block copolymer of polyamide and polyether.

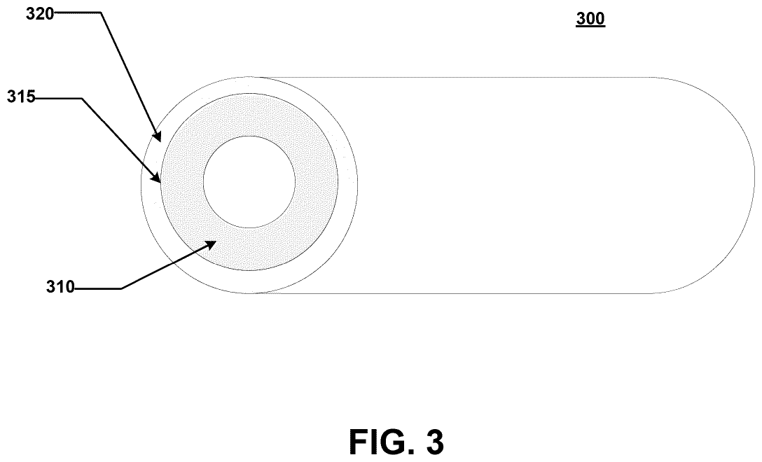

For purposes of illustration, FIG. 3 shows a tubular article 300 formed according to embodiments described herein. As shown in FIG. 3, tubular article 300 may include a tubing component 310 having a surface 315 and a coating component 320 overlying the surface 315 of the tubing component 310.

According to particular embodiments, the surface 315 of the tubing component 310 may include a particular material. For example, the surface 315 of the tubing component 310 may include a silicone elastomer. In another embodiment, the surface 315 of the tubing component 310 includes a copolymer or block polymer as described above. In yet another embodiment, the surface 315 of the tubing component 310 includes a fluoropolymer. According to particular embodiments, the surface 315 of the tubing component 310 may consist of a particular material. For example, the surface 315 of the tubing component 310 may consist of a silicone elastomer.

According to still other embodiments, the tubing component 310 may have a particular wall thickness (WT). For example, the tubing component 310 may have a wall thickness (WT) of at least about 0.025 mm, such as, at least about 0.05 mm or at least about 0.075 mm or at least about 0.1 mm or at least about 5 mm or at least about 10 mm or at least about 15 mm or at least about 20 mm or at least about 25 mm or at least about 50 mm or at least about 75 mm or at least about 100 mm or even at least about 125 mm. According to yet other embodiments, the tubing component 410 may have a wall thickness (WT) of not greater than about 250 mm, such as, not greater than about 225 mm or not greater than about 200 mm or not greater than about 175 mm or even not greater than about 150 mm. It will be appreciated that the wall thickness (WT) of the tubing component 310 may be within a range between and including any of the minimum and maximum values noted above. It will be further appreciated that the wall thickness (WT) of the tubing component 310 may be any value between and including any of the minimum and maximum values noted above.

According to still other embodiments, the tubing component 310 may have a particular outer diameter (OD). For example, the outer diameter (OD) of the tubing component 310 may be at least about 0.25 mm, such as at least about 0.5 mm, such as at least about 1.0 mm, such as at least about 1.5 mm, such as at least about 2.0 mm, such as at least about 5.0 mm, such as at least about 10.0 mm, such as at least about 15.0 mm, or even at least about 20.0 mm. According to still other embodiments, the outer diameter (OD) of the tubing component 310 may be not greater than about 100.0 mm, such as not greater than about 75.0 mm, such as not greater than 50.0 mm, such as not greater than about 45.0 mm, or even not greater than 40.0 mm. It will be appreciated that the outer diameter (OD) of the tubing component 310 may be within a range between and including any of the minimum and maximum values noted above. It will be further appreciated that the outer diameter (OD) of the tubing component 310 may be any value between and including any of the minimum and maximum values noted above.

According to still other embodiments, the tubing component 310 may have a particular inner diameter (ID). For example, the inner diameter (ID) of the tubing component 310 may be at least about 0.1 mm, such as at least about 0.2 mm, such as at least about 0.3 mm, such as at least about 0.5 mm, such as at least about 1.0 mm, or even at least about 1.5 mm. According to still other embodiments, the inner diameter (ID) of the tubing component 310 may be not greater than about 50.0 mm, such as not greater than about 45.0 mm, such as not greater than 40.0 mm, such as not greater than 35.0 mm, or even not greater than 30.0 mm. It will be appreciated that the inner diameter (ID) of the tubing component 310 may be within a range between and including any of the minimum and maximum values noted above. It will be further appreciated that the inner diameter (ID) of the tubing component 310 may be any value between and including any of the minimum and maximum values noted above. Furthermore, it will be appreciated that the inner diameter (ID) will be a value that is less than the outer diameter (OD) of the tubing component 310.

According to still other embodiments, the surface 315 of the tubing component 310 including the crosslinked coating may be the outer surface of the tubing component 310 as shown in FIG. 3. According to yet other embodiments, the surface 315 of the tubing component 310 including the crosslinked coating may be the inner surface of the tubing component (not shown in FIG. 3).

According to other embodiments, the coating component 320 may include a polyvinyl alcohol based component. According to particular embodiments, the polyvinyl alcohol based component of the coating component 320 may include a polyvinyl alcohol, a polyvinyl alcohol copolymer, a polyvinyl alcohol oligomer, or any combination thereof. According to other embodiments, the polyvinyl alcohol based component of the coating component 320 may consist of a polyvinyl alcohol, a polyvinyl alcohol copolymer, a polyvinyl alcohol oligomer, or any combination thereof.

According to still other embodiments, the coating component 320 may further include a secondary material. For example, the coating component 320 may further include poly(ethylene glycol) (PEG). According to still other embodiments, the coating component 320 may include chitosan. According to yet other embodiments, the coating component 320 may include poly(acrylic acid).

According to still other embodiments, the coating component 320 may have a particular thickness. For example, the coating component 320 may have a thickness of at least about 1 nm, such as, at least about 5 nm or at least about 10 nm or at least about 15 nm or at least about 20 nm or at least about 25 nm or at least about 30 nm or at least about 35 nm or at least about 40 nm or at least about 45 nm or even at least about 50. According to still other embodiments, the coating component 320 may have a thickness of not greater than about 2 μm, such as, not greater than about 95 nm or not greater than about 90 nm or not greater than about 85 nm or even not greater than about 80 nm. It will be appreciated that the thickness of the coating component 320 may be within a range between and including any of the minimum and maximum values noted above. It will be further appreciated that the thickness of the coating component 320 may be any value between and including any of the minimum and maximum values noted above.

According to certain embodiments, the polyvinyl alcohol based component is cross-linked. A component is considered cross-linked if at least one polymeric chain within the component is chemically bonded to another polymeric chain within the component. According to certain embodiments, the coating component 320 is cross-linked to the surface 315 of the tubing component 310. A component is considered cross-linked to another component if at least one polymeric chain within a component is chemically bonded to another polymeric chain within the other component.

According to particular embodiments, cross-linking of the polyvinyl alcohol based component may decrease the swelling of the polyvinyl alcohol when submerged in a deionized water for 24 hours as described in the Examples. Typically, before crosslinking, the polyvinyl alcohol based component swells appreciably when immersed in water. However, once cross-linked, the cross-linked polyvinyl alcohol based component loses the ability to swell to the same degree. According to certain embodiments, the percentage mass increase of the submerged crosslinked polyvinyl alcohol based component decreases compared to the uncrosslinked component by at least about 10%, such as at least about 20%, such as at least about 30%, such as at least about 40%, such as at least about 50%, or even at least about 60%. It will be appreciated that the percentage mass decrease of the polyvinyl alcohol based component may be within a range between and including any of the values noted above. It will be further appreciated that the percentage mass decrease of the polyvinyl alcohol based component may be any value between and including any of the values noted above.

According to particular embodiments, cross-linking of the polyvinyl alcohol based component may decrease the solubility of the polyvinyl alcohol based component by a particular percentage. When the material is uncrosslinked, the polyvinyl alcohol based component is fully dissolvable in a water solution. When the material is crosslinked, the polyvinyl alcohol based component can be, at most, only partially dissolved in a water solution. In an embodiment, this may be quantified by measuring a mass of a cross-linked polyvinyl alcohol based component that does not dissolve when immersed in water solution divided by the total mass of the cross-linked polyvinyl alcohol based component prior to immersion. According to certain embodiments, the percentage solubility decrease of the polyvinyl alcohol based component may be at least about 50%, such as, at least about 55% or at least about 60% or at least about 65% or at least about 70% or even at least about 75%. It will be appreciated that the percentage solubility decrease of the polyvinyl alcohol based component may be within a range between and including any of the values noted above. It will be further appreciated that the percentage solubility decrease of the polyvinyl alcohol based component may be any value between and including any of the values noted above.

According to particular embodiments, an exposed surface of the coating component (i.e., the surface not contacting the structural component) may have a particular lubricious coefficient of friction as measured against a piece of PVOH-coated polyamide-polyether block polymer using a TA-XT2i Texture Analyzer (Texture Technologies Corp). For example, the lubricious coefficient of friction of the exposed surface of the coating component 320 may be not greater than about 0.95, such as, not greater than about 0.9 or not greater than about 0.85 or not greater than about 0.8 or not greater than about 0.75 or not greater than about 0.7 or not greater than about 0.65 or not greater than about 0.6 or not greater than about 0.55 or not greater than about 0.5 or not greater than about 0.45 or not greater than about 0.4 or not greater than about 0.35 or not greater than about 0.3 or not greater than about 0.25 or not greater than about 0.2 or not greater than about 0.15 or not greater than about 0.1 or not greater than about 0.05. It will be appreciated that the lubricious coefficient of friction of the exposed surface of the coating component may be within a range between and including any of the values noted above. It will be further appreciated that the lubricious coefficient of friction of the exposed surface of the coating component may be any value between and including any of the values noted above.

According to still other embodiments, the coating component may have a particular water contact angle as measure according to an adapted version of ASTM D7334-08, where the standard is adapted by using a static contact angle as opposed to an advancing contact angle. For example, the coating component may have a water contact angle of not greater than about 50°, not greater than about 45°, such as, not greater than about 43° or not greater than about 40° or not greater than about 38° or even not greater than about 35°. According to yet other embodiments, the coating component may have a water contact angle of at least about 10°, such as, at least about 15°, at least about 20°, at least about 25°, or even at least about 30°. It will be appreciated that the contact angle of the coating component may be within a range between and including any of the minimum and maximum values noted above. It will be further appreciated that the contact angle of the coating component may be any value between and including any of the minimum and maximum values noted above. Notably, the surface of the structural component of the polymer material typically has a water contact angle of greater than 80°.

In an embodiment, the modification of the surface of the structural component provides additional advantageous properties. For instance, when the surface of the structural component is a silicone elastomer, the modification may provide at least one of the following characteristics: a reduction in the absorption of a protein; a reduction in fouling, a reduction in dust pick-up, a reduction in the loss of preservatives; a reduction of friction coefficient, an increase in the pump performance when the structural component is a tube; a reduction on the impact of an environmental atmosphere to a drug inside tubing; and/or a reduction of adhesion between adjacent silicone surfaces during a sterilization process, an active surface on which to incorporate additional functionality. Any additional functionality is envisioned that provides a desirable property to the surface of the structural component, such as, for example, an antimicrobial functionality.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a composite article, wherein the method includes: providing a structural component with a surface, wherein the surface includes a silicone elastomer, a fluoropolymer, or a copolymer or a block polymer wherein the copolymer or block copolymer comprises a polyolefin block, a polyether block, a polyurethane block, a polyamide block, a polyester block, a styrene block copolymer, a polyvinyl chloride (PVC), or any combination thereof; optionally pre-treating the surface with an ionized gas treatment; coating the surface of the structural component with a precursor coating component, wherein the precursor coating component includes a polyvinyl alcohol based component, and treating the precursor coating component to form a crosslinked coating layer overlying the surface of the structural component.

Embodiment 2. The method of embodiment 1, wherein coating the structural component includes a wet-coating process.

Embodiment 3. The method of embodiment 2, wherein the wet-coating process is a dip-coating process.

Embodiment 4. The method of embodiment 3, wherein the dip-coating process includes passing the structural component through a coating solution.

Embodiment 5. The method of embodiment 4, wherein the coating solution includes the polyvinyl alcohol based component and water.

Embodiment 6. The method of any one of the preceding embodiments, wherein the wet-coating process is a spray-coating process.

Embodiment 7. The method of any one of the preceding embodiments, wherein the wet-coating process includes a batch coating process.

Embodiment 8. The method of any one of the preceding embodiments, wherein the wet-coating process includes a continuous coating process.

Embodiment 9. The method of any one of the preceding embodiments, wherein the wet-coating process includes more than one pass.

Embodiment 10. The method of any one of the preceding embodiments, wherein the ionized gas treatment ionizes a gas such as oxygen, helium, argon, nitrogen, compressed air, water vapor, or combination thereof.

Embodiment 11. The method of embodiment 10, wherein the plasma pre-treatment is provided for less than 5 minutes, such as less than 2 minutes, such as less than 1 minute, such as less than 45 seconds, such as less than 30 seconds, or even less than 10 seconds.

Embodiment 12. The method of any one of the preceding embodiments, wherein treating the precursor coating component includes plasma treating the precursor coating component, UV radiation cross-linking the precursor coating component, e-beam radiation cross-linking the precursor coating component, gamma radiation cross-linking the precursor coating component, or combination thereof.

Embodiment 13. The method of any one of the preceding embodiments, wherein the polyvinyl alcohol based component includes a polyvinyl alcohol, a polyvinyl alcohol copolymer, a polyvinyl alcohol oligomer, or any combination thereof.

Embodiment 14. The method of embodiment 13, wherein the polyvinyl alcohol based component further includes poly(ethylene glycol), chitosan, poly(acrylic acid), or combination thereof.

Embodiment 15. The method of any one of the preceding embodiments, wherein the crosslinked coating layer includes a polyvinyl alcohol based component content of at least about 75 wt. % for a total weight of the crosslinked coating layer.

Embodiment 16. The method of any one of the preceding embodiments, wherein the crosslinked coating layer includes a polyvinyl alcohol content of not greater than about 100 wt. % of the total weight of the crosslinked coating layer.

Embodiment 17. The method of any one of the preceding embodiments, wherein the total weight percent of the polyvinyl alcohol based component in the coating solution is less than 20 percent, such as less than 10 percent, such as less than 5 percent, such as less than 2 percent, such as less than 1 percent.

Embodiment 18. The method of any one of the preceding embodiments, wherein the crosslinked coating layer includes a thickness of at least about 1 nm.

Embodiment 19. The method of any one of the preceding embodiments, wherein the crosslinked coating layer includes a thickness of not greater than about 2 μm.

Embodiment 20. The method of any one of the preceding embodiments, wherein the structural component includes a thickness of at least about 0.025 mm.

Embodiment 21. The method of any one of the preceding embodiments, wherein the structural component includes a thickness of not greater than about 250 mm.

Embodiment 22. The method of any one of the preceding embodiments, wherein the silicone elastomer includes a polyorganosiloxane.

Embodiment 23. The method of any one of the preceding embodiments, wherein the coating layer is cross-linked to the surface of the structural component.

Embodiment 24. The method of any one of the preceding embodiments, wherein the polyvinyl alcohol within the coating layer is cross-linked.

Embodiment 25. The method of any one of the preceding embodiments, wherein a lubricious coefficient of friction of an exposed surface of the crosslinked coating layer is not greater than about 0.95, not greater than about 0.9, not greater than about 0.85, not greater than about 0.8, not greater than about 0.75, not greater than about 0.7, not greater than about 0.65, not greater than about 0.6, not greater than about 0.55, not greater than about 0.5, not greater than about 0.45, not greater than about 0.4, not greater than about 0.35, not greater than about 0.3, not greater than about 0.25, not greater than about 0.2, not greater than about 0.15, not greater than about 0.1, or not greater than about 0.05.

Embodiment 26. The method of any one of the preceding embodiments, wherein a water contact angle of the crosslinked coating layer is at least about 10°.

Embodiment 27. The method of any one of the preceding embodiments, wherein a water contact angle of the crosslinked coating layer is not greater than about 50°.

Embodiment 28. The method of any one of the preceding embodiments, wherein the surface is an inner surface of a tube.

Embodiment 29. The method of any one of the preceding embodiments, wherein the surface is an outer surface of a tube.

Embodiment 30. An article made by the method of any one of embodiments 1-29.

Embodiment 31. A composite article including a structural component including a surface including a silicone elastomer, a fluoropolymer, or a copolymer or a block polymer wherein the copolymer or block copolymer comprises a polyolefin block, a polyether block, a polyurethane block, a polyamide block, a polyester block, a styrene block copolymer, a polyvinyl chloride (PVC), or any combination thereof, and a crosslinked coating layer overlying the surface of the structural component, wherein the crosslinked coating layer includes a polyvinyl alcohol based component.

Embodiment 32. The composite article of embodiment 31, wherein the polyvinyl alcohol based component includes a polyvinyl alcohol, a polyvinyl alcohol copolymer, a polyvinyl alcohol oligomer, or any combination thereof.

Embodiment 33. The composite article of any one of embodiments 31-32, wherein the crosslinked coating layer further includes PEG, chitosan, poly(acrylic acid), or combination thereof.

Embodiment 34. The composite article of any one of embodiments 31-33, wherein the crosslinked coating layer includes a polyvinyl alcohol based component content of at least about 75 wt. % for a total weight of the crosslinked coating layer.

Embodiment 35. The composite article of any one of embodiments 31-34, wherein the crosslinked coating layer includes a polyvinyl alcohol content of not greater than about 100 wt. % of the total weight of the crosslinked coating layer.

Embodiment 36. The composite article of any one of embodiments 31-35, wherein the crosslinked coating layer includes a thickness of at least about 1 nm.

Embodiment 37. The composite article of any one of embodiments 31-36, wherein the crosslinked coating layer includes a thickness of not greater than about 2 μm.

Embodiment 38. The composite article of any one of embodiments 31-37, wherein the structural component includes a thickness of at least about 0.025 mm.

Embodiment 39. The composite article of any one of embodiments 31-38, wherein the structural component includes a thickness of not greater than about 250 mm.

Embodiment 40. The composite article of any one of embodiments 31-39, wherein the silicone elastomer includes a polyorganosiloxane.

Embodiment 41. The composite article of any one of embodiments 31-40, wherein the coating layer is cross-linked to the surface of the structural component.

Embodiment 42. The composite article of any one of embodiments 31-41, wherein the polyvinyl alcohol within the crosslinked coating layer is cross-linked.

Embodiment 43. The composite article of any one of embodiments 31-42, wherein a lubricious coefficient of friction of an exposed surface of the crosslinked coating layer is not greater than about 0.95, not greater than about 0.9, not greater than about 0.85, not greater than about 0.8, not greater than about 0.75, not greater than about 0.7, not greater than about 0.65, not greater than about 0.6, not greater than about 0.55, not greater than about 0.5, not greater than about 0.45, not greater than about 0.4, not greater than about 0.35, not greater than about 0.3, not greater than about 0.25, not greater than about 0.2, not greater than about 0.15, not greater than about 0.1, or even not greater than about 0.05.

Embodiment 44. The composite article of any one of embodiments 31-43, wherein a water contact angle of the crosslinked coating layer is at least about 10°.

Embodiment 45. The composite article of any one of embodiments 31-44, wherein a water contact angle of the crosslinked coating layer is not greater than about 50°.

Embodiment 46. The composite article of any one of embodiments 31-45, wherein the composite article is in the form of a tube.

Embodiment 47. The composite article of any one of embodiments 31-46, wherein the composite article is in the form of a container.

Embodiment 48. A tubular article including a surface including a silicone elastomer, and a crosslinked coating layer overlying the surface of the tubing component, wherein the crosslinked coating layer includes a polyvinyl alcohol based component.

Embodiment 49. The tubular article of embodiment 48, wherein the surface is an outer surface of the tubing component.

Embodiment 50. The tubular article of embodiment 48, wherein the surface is an inner surface of the tubing component.

Embodiment 51. The tubular article of embodiment 48, wherein the coating component includes a thickness of at least about 1 nm.

Embodiment 52. The tubular article of embodiment 51, wherein the coating component includes a thickness of not greater than about 2 μm.

Embodiment 53. The tubular article of embodiment 48, wherein the tubing component includes a tubing wall thickness (WT) of at least about 0.025 mm.

Embodiment 54. The tubular article of embodiment 53, wherein the tubing component includes a tubing wall thickness (WT) of not greater than about 250 mm.

Embodiment 55. The tubular article of embodiment 48, wherein the tubing component has an outer diameter (OD) of at least about 0.25 mm.

Embodiment 56. The tubular article of embodiment 55, wherein the tubing component has an outer diameter (OD) of not greater than about 100.0 mm.

Embodiment 57. The tubular article of embodiment 48, wherein the tubing component has an inner diameter (ID) of at least about 0.1 mm.

Embodiment 58. The tubular article of embodiment 57, wherein the tubing component has an inner diameter (ID) of not greater than about 50.0 mm.

Embodiment 59. A container article including an inner surface including a silicone elastomer, and a crosslinked coating layer overlying the inner surface of the tubing component, wherein the crosslinked coating layer includes a polyvinyl alcohol based component.

Embodiment 60. The container article of embodiment 59, wherein the container article is a bag or a cartridge used for cell culture.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1: Hydrophilic, Low Coefficient of Friction Polyether-Polyamide Copolymer Catheter Tubing

Method of preparing hydrophilic, low coefficient of friction coating via dip coating.

### Preparation of Coating Solution:

2 wt. % polyvinyl alcohol (M_{w} 89,000-98,000, 99+% hydrolyzed, Sigma-Aldrich) was dissolved in deionized (DI) water. Dissolution was facilitated by heating the solution up to 80° C. under constant magnetic mixing until translucent.

### Coating:

Dip coating was performed on polyether-polyamide copolymer slabs and catheter tubing. Samples were immersed in coating solution for 2-minutes. Upon removal, the samples were submerged in a DI water bath to remove any weakly physiosorbed materials and then dried in ambient conditions.

### Properties:

Contact angle measurements were performed on the polyether-polyamide copolymer surface to determine hydrophilicity. Polyether-polyamide copolymer has an intrinsic contact angle of 80° C. After coating, the contact angle of the surface was reduced to 25°.

Coefficient of friction was measured using a TA-XT2i Texture Analyzer (Texture Technologies Corp). In this experiment, a film of water was applied between two polyether-polyamide copolymer samples to measure coefficient of friction in the lubricious state. A smaller sample was affixed to a weight and pulled over a larger sample at a constant speed (3 in/min). The frictional force was measured by the instrument throughout the duration of the test. The uncoated sample displayed stick-slip behavior while the coated PVOH sample showed drastically reduced coefficient of friction. Relative coefficients of friction were 1.00±0.12 for the uncoated sample and 0.15±0.12 for the coated sample.

### Example 2: Plasma Crosslinking of PVOH Films

Method to crosslink the surface of polyvinyl alcohol films via atmospheric plasma beam.

### Preparation of PVOH Films:

2 wt. % polyvinyl alcohol solution was prepared according to the procedure in Example 1.

Pure polyvinyl alcohol films were formed by drying the solution in a glass dish. The dried polyvinyl alcohol film was removed from the glass and cut into rectangular films.

### Plasma Crosslinking:

Plasma crosslinking was performed using a Surfx in-line plasma cleaner (Surfx Technologies, LLC.). Crosslink parameters are provided in Table 1 below. Polyvinyl alcohol films were exposed to plasma on one or both sides in order to evaluate crosslinking.

TABLE 1
Plasma crosslinking parameters.

| Specification | Value |
|---|---|
| Plasma Gas | 40.0 L/min Ar (98.8%) |
| | 0.5 L/min N₂ (1.2%) |
| Power | 580 W |
| Plasma Head Temperature | 60° C. |
| Plasma Scan Speed | 20 mm/s (2 passes) |
| Treatment Distance | 2 mm |

### Swelling:

As a hydrogel, polyvinyl alcohol swells when immersed into water. Increasing the amount of crosslinking within the material reduced the flexibility of the hydrogel network and thus reduced the ability for polyvinyl alcohol to swell. Polyvinyl alcohol films were crosslinked on one or both sides. To evaluate swelling, polyvinyl alcohol films were immersed in DI water for 24 hours. The mass increase of the films after swelling was recorded and shown in Table 2. Increasing plasma exposure resulted in more crosslinking and a decrease in mass gain after immersion in water.

TABLE 2
Polyvinyl alcohol swelling behavior after plasma
crosslinking treatment (24-hour water bath).

| | Mass Increase |
|---|---|
| Sample | (%) |
| Polyvinyl alcohol, uncrosslinked | 457% |
| Polyvinyl alcohol, plasma crosslink, 1 side | 380% |
| Polyvinyl alcohol, plasma crosslink, 2 side | 287% |

### Dissolution:

Crosslinking decreases solubility as polymer chains are molecularly bound to each other. Plasma treatment results only in surface crosslinking, so a thin layer of surface crosslinked material exists upon a bulk of uncrosslinked material. Dissolution was studied by immersing polyvinyl alcohol films into DI water at 80° C. under mechanical stirring. Uncrosslinked films dissolved completely in under 10 seconds. Crosslinked polyvinyl alcohol did not fully dissolve after 1 minute of immersion.

### Example 3: Polyvinyl Alcohol Coating of Silicone

Application of crosslinked polyvinyl alcohol films to silicone surface for hydrophilicity, low lubricious coefficient of friction, and low tack surface.

### Preparation of Coating Solution:

6 wt. % polyvinyl alcohol solution (M_{w} 89,000-98,000, 99+% hydrolyzed, Sigma-Aldrich) was dissolved in deionized (DI) water. Dissolution was facilitated by heating the solution up to 80° C. under constant magnetic mixing until translucent.

### Plasma Pre-Treatment of Silicone:

Polyvinyl alcohol spontaneously crystallizes on most hydrophobic polymer surfaces. However, due to the phenomenon of hydrophobic recovery, this ability typically does not extend to silicone. Atmospheric plasma pre-treatment of the silicone substrate prior to dip coating was shown to be an effective means to create a uniform polyvinyl alcohol coating.

Coating was performed on platinum-cured silicone tubing. The effects of plasma exposure on the coating quality were studied by controlling the “sweeps” or “passes” that the plasma head made over the silicone substrate at a constant power (565 W), speed (15 mm/s) and separation distance from the tip of the plasma head to the substrate (2 mm). Without pre-treatment, dip coating typically results in non-uniform, splotchy coating as revealed in contact angle measurements. Increasing plasma pre-treatment resulted in a more uniform hydrophilic coating, as shown in Table 3.

TABLE 3
Effect of increase plasma pre-treatment
exposure on polyvinyl alcohol coating.

| Sample | Mean WCA |
|---|---|
| No Pretreatment | 91.5 ± 16.0 |
| 1 Pass Pre-Treatment | 70.3 ± 17.2 |
| 2 Pass Pre-Treatment | 52.8 ± 6.8 |
| 4 Pass Pre-Treatment | 48.2 ± 4.2 |

### Plasma Crosslinking:

After dip coating, the polyvinyl alcohol may be dried at ambient conditions and then crosslinked according to the plasma parameters presented in Example 2. Alternatively, the coating may be crosslinked via the same parameters while still wet. Crosslinking in this state is expected to increase the depth of plasma crosslinking as ions and radicals may diffuse through the water-swollen polymer.

Crosslinking advantageously retained a uniform, hydrophilic structure on silicone surfaces. Otherwise, hydrophobic recovery at the silicone surface resulted in visible cracking and loss of hydrophilicity of the polyvinyl alcohol coating in as little as 24 hours. In contrast, plasma crosslinking resulted in an unchanged contact angle after 24 hours.

TABLE 4
Hydrophobic recovery of crosslinked and uncrosslinked
polyvinyl alcohol coatings on silicone surface.

| Coating | Age | Water Contact Angle | Appearance |
|---|---|---|---|
| Polyvinyl alcohol, | 24 hrs | 70° | Surface |
| uncrosslinked | | | cracking |
| Polyvinyl alcohol, | 24 hrs | 48° | Smooth, |
| crosslinked | | | uniform |

### Coefficient of Friction:

Coefficient of friction of crosslinked polyvinyl alcohol coatings as applied to platinum-cured silicone tubing was measured using a custom tube tribometer. The tribometer was equipped with two force transducers that measure the normal force and the tangential force observed on a tube under testing. The tube was affixed to a force transducer on one end and fed between a rotating roller and a stationary bar. The normal force on the stationary bar was set to 3N. The system measured the tangential force as the roller pulled on the tube during rotation. In order to test “lubricated” coefficient of friction, the tubes were first fully immersed in water. Water was then applied to the roller for the duration of the test to keep it hydrated. Coefficient of friction of the polyvinyl alcohol coating was equivalent to the silicone surface in the dry state, but showed markedly reduced (−80%) friction in the hydrated, lubricious state. The coefficient of friction remained constant throughout a 20-minute test, displaying the durability of the crosslinked coating.

TABLE 5
Parameters for tube tribometer CoF measurements.

| Specification | Value |
|---|---|
| Tube Material | Platinum-cured silicone tubing |
| | (0.250″ ID, 0.062″ OD) |
| Normal Force | 3 N |
| Roller Speed | 50 rpm |
| Duration | 1200 s |

TABLE 6
Coefficient of friction for pristine and coated platinum-cured silicone
tubing. Performed in the dry and wet (lubricous) state.

| Sample | State | CoF |
|---|---|---|
| Platinum-cured silicone tubing control | Dry | 1.14 ± 0.08 |
| Polyvinyl alcohol, crosslinked | Dry | 1.14 ± 0.04 |
| Platinum-cured silicone tubing Control | Wet | 1.03 ± 0.09 |
| Polyvinyl alcohol, crosslinked | Wet | 0.21 ± 0.04 |

### Tack Testing:

Silicone is typically a tacky material, leading to high dust pick up and self-sticking. A tack test was performed using a TA-XT2i Texture Analyzer (Texture Technologies Corp) on a cured liquid silicone rubber (LSR) slab with and without a polyvinyl alcohol coating. Coating of polyvinyl alcohol resulted in reduction of tack energy by 62%.

TABLE 7
Tack energy pristine and coated LSR rubber.

| Sample | Tack Energy (N/mm²) |
|---|---|
| LSR Rubber | 0.091 ± 0.019 |
| LSR Rubber + polyvinyl | 0.035 ± 0.016 |
| alcohol | |

### Example 4: Antimicrobial Polyvinyl Alcohol Coating

Polyvinyl alcohol coatings used to impart antimicrobial functionality on fluoropolymer films.

### Preparation of Polyvinyl Alcohol Coatings:

2 wt. % polyvinyl alcohol solution (M_{w} 89,000-98,000, 99+% hydrolyzed, Sigma-Aldrich) was dissolved in deionized (DI) water. Dissolution was facilitated by heating the solution up to 80° C. under constant magnetic mixing until translucent.

FEP or ETFE films were cut into approximately 2×2 in. squares prior to coating. These squares were washed using IPA to wipe away all debris. Following cleaning, films were fully submerged into the polyvinyl alcohol solution for three minutes. Once coating was completed, the films were submerged into DI water for a one-minute rinse procedure to remove any weakly physisorbed material. The coated film could then be dried in ambient conditions or immediately subjected to plasma crosslinking.

### Grafting Antimicrobial Species:

Quaternary ammonium salts (QAS) are well known antimicrobial compounds typically formed as chlorides or bromides. QAS which are composed of alkoxysilane groups are able to form covalent Si—O bonds with hydroxyl surfaces under acidic conditions. 42 wt. % dimethyloctadecyl [3-(trimethoxysilyl) propyl] ammonium chloride in methanol was supplied from Sigma-Aldrich. A QAS grafting solution was prepared according to a dilution in DI water as presented below:

TABLE 8
QAS grafting solution components.

| Component | Mass Percent |
|---|---|
| Dimethyloctadecyl[3- | 2.4 |
| (trimethoxysilyl)propyl] ammonium | |
| chloride | |
| Methanol | 3.4 |
| DI water | 94.2 |

Polyvinyl alcohol coated ETFE films were suspended in the QAS grafting solution for 5 minutes. Grafting was performed under constant mixing via magnetic stir bar at 90 rpm. After grafting, the films were fully immersed and agitated in water for one minute to remove any unbound material.

### Antimicrobial Testing:

Antimicrobial testing was performed according to JIS Z 2801/ISO 22196:2011 standards for determining antibacterial activity on plastics and other non-porous surfaces. Films were tested against Escherichia coli (E. coli) and Staphylococcus aureus (S. aureus) for contact times of 24 hours.

Crosslinking of the polyvinyl alcohol films displayed an increase in the surface grafting of QAS species to the surface, thereby increasing the antibacterial activity of the films. The antimicrobial function was very effective against gram-positive bacteria (S. aureus) and moderately effective against gram-negative bacteria (E. coli).

TABLE 9
Antibacterial activity of QAS-polyvinyl alcohol coatings.

| Sample | Test Parameter | S. Aureus | E. Coli |
|---|---|---|---|
| PVOH, | Antibacterial Activity | 1.65 | 0.5 |
| uncrosslinked | Value | | |
| | Percent Reduction | 97.76% | 63.38% |
| PVOH, | Antibacterial Activity | 2.18 | 0.84 |
| crosslinked | Value | | |
| | Percent Reduction | 99.34% | 85.55% |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of forming a composite article, wherein the method comprises:
providing a structural component with a surface, wherein the surface comprises a silicone elastomer, a fluoropolymer, or a copolymer or a block polymer wherein the copolymer or block copolymer comprises a polyolefin block, a polyether block, a polyurethane block, a polyamide block, a polyester block, a styrene block copolymer, a polyvinyl chloride (PVC), or any combination thereof;
optionally pre-treating the surface with an ionized gas treatment;
coating the surface of the structural component with a precursor coating component, wherein the precursor coating component comprises a polyvinyl alcohol based component, and
treating the precursor coating component to form a crosslinked coating layer overlying the surface of the structural component.

2. The method of claim 1, wherein coating the structural component comprises a wet-coating process.

3. The method of claim 2, wherein the wet-coating process is a dip-coating process, a spray-coating process, a batch coating process, or a continuous coating process.

4. The method of claim 3, wherein the dip-coating process comprises passing the structural component through a coating solution comprising the polyvinyl alcohol based component and water.

5. The method of claim 1, wherein the ionized gas treatment ionizes a gas comprising oxygen, helium, argon, nitrogen, compressed air, water vapor, or combination thereof.

6. The method of claim 1, wherein treating the precursor coating component comprises plasma treating the precursor coating component, UV radiation cross-linking the precursor coating component, e-beam radiation cross-linking the precursor coating component, gamma radiation cross-linking the precursor coating component, or combination thereof.

7. The method of claim 1, wherein the polyvinyl alcohol based component comprises a polyvinyl alcohol, a polyvinyl alcohol copolymer, a polyvinyl alcohol oligomer, or any combination thereof.

8. The method of claim 7, wherein the polyvinyl alcohol based component further comprises poly(ethylene glycol), chitosan, poly(acrylic acid), or combination thereof.

9. The method of claim 1, wherein the total weight percent of the polyvinyl alcohol based component in the coating solution is less than 20 percent, such as less than 10 percent, such as less than 5 percent, such as less than 2 percent, such as less than 1 percent.

10. A composite article comprising a structural component comprising a surface comprising a silicone elastomer, a fluoropolymer, or a copolymer or a block polymer, wherein the copolymer or the block polymer comprises a polyolefin block, a polyether block, a polyurethane block, a polyamide block, a polyester block, a styrene block copolymer, a polyvinyl chloride (PVC), or any combination thereof, and a crosslinked coating layer overlying the surface of the structural component, wherein the crosslinked coating layer comprises a polyvinyl alcohol based component.

11. The composite article of claim 10, wherein the polyvinyl alcohol based component comprises a polyvinyl alcohol, a polyvinyl alcohol copolymer, a polyvinyl alcohol oligomer, or any combination thereof.

12. The composite article of claim 10, wherein the crosslinked coating layer further comprises PEG, chitosan, poly(acrylic acid), or combination thereof.

13. The composite article of claim 10, wherein the crosslinked coating layer comprises a polyvinyl alcohol based component content of at least about 75 wt. % and not greater than about 100 wt. % of a total weight of the crosslinked coating layer.

14. The composite article of claim 10, wherein the crosslinked coating layer comprises a thickness of at least about 1 nm and not greater than about 2 μm.

15. The composite article of claim 10, wherein the coating layer is cross-linked to the surface of the structural component.

16. The composite article of claim 10, wherein the polyvinyl alcohol within the crosslinked coating layer is cross-linked.

17. The composite article of claim 10, wherein a lubricious coefficient of friction of an exposed surface of the crosslinked coating layer is not greater than about 0.95, not greater than about 0.9, not greater than about 0.85, not greater than about 0.8, not greater than about 0.75, not greater than about 0.7, not greater than about 0.65, not greater than about 0.6, not greater than about 0.55, not greater than about 0.5, not greater than about 0.45, not greater than about 0.4, not greater than about 0.35, not greater than about 0.3, not greater than about 0.25, not greater than about 0.2, not greater than about 0.15, not greater than about 0.1, or not greater than about 0.05.

18. The composite article of claim 10, wherein a water contact angle of the crosslinked coating layer is at least about 10° and not greater than about 50°.

19. The composite article of claim 10, wherein the composite article is in the form of a container.

20. A tubular article comprising a surface comprising a silicone elastomer, and a crosslinked coating layer overlying the surface of the tubing component, wherein the crosslinked coating layer comprises a polyvinyl alcohol based component.
